(19) United States
(12) Patent Application Publication
(10) Pub. No.: US 2011/0231128 A1
(43) Pub. Date: Sep. 22, 2011

(54) TEST APPARATUS, MEASUREMENT APPARATUS, AND ELECTRONIC DEVICE

(75) Inventors: Masakatsu SUDA, Saitama (JP); Yusuke HAYASE, Saitama (JP)

(73) Assignee: ADVANTEST CORPORATION, Tokyo (JP)

(21) Appl. No.: 13/009,794

(22) Filed: Jan. 19, 2011

(30) Foreign Application Priority Data
Jan. 28, 2010 (JP) 2010-017462

(51) Int. Cl. G06F 19/00

(52) U.S. Cl. 702/75

(57) ABSTRACT

A test apparatus that judges pass/fail of a signal under measurement, comprising a frequency counter that repeatedly performs a counting step of counting the number of pulses of a reference signal whose period is known and the number of pulses of the signal under measurement in parallel within the same measurement period; an average period calculating section that calculates, for each counting step, an average period of the signal under measurement within the measurement period, based on a period of the reference signal and a ratio between the number of pulses of the signal under measurement and the number of pulses of the reference signal counted within the same measurement period; a noise calculating section that calculates spread of the average periods calculated by the average period calculating section; and a judging section that judges pass/fail of the signal under measurement based on the spread of the average periods.

### BACKGROUND

1. Technical Field

The present invention relates to a test apparatus, a measurement apparatus, and an electric device.

2. Related Art

A conventional technique for testing a device under test, such as a semiconductor device, involves measuring noise included in a signal under measurement output by the device under test. For example, Japanese Patent Application Publication No. 2001-337121 describes techniques of using a time interval analyzer to measure jitter and converting an input signal into a complex analytic signal to measure jitter.

When using a time interval analyzer or the like to measure jitter, however, the measurement cost increases. When using an analytic signal, the computation for the measurement data becomes complicated.

### SUMMARY

Therefore, it is an object of an aspect of the innovations herein to provide a test apparatus, a measurement apparatus, and an electric device, which are capable of overcoming the above drawbacks accompanying the related art. The above and other objects can be achieved by combinations described in the independent claims. According to a first aspect related to the innovations herein, provided is a test apparatus that judges pass/fail of a signal under measurement, comprising a frequency counter that repeatedly performs a counting step of counting the number of pulses of a reference signal whose period is known and the number of pulses of the signal under measurement in parallel within the same measurement period; an average period calculating section that calculates, for each counting step, an average period of the signal under measurement within the measurement period, based on a period of the reference signal and a ratio between the number of pulses of the signal under measurement and the number of pulses of the reference signal counted within the same measurement period; a noise calculating section that calculates spread of the average periods calculated by the average period calculating section; and a judging section that judges pass/fail of the signal under measurement based on the spread of the average periods.

The summary clause does not necessarily describe all necessary features of the embodiments of the present invention. The present invention may also be a sub-combination of the features described above.

### BRIEF DESCRIPTION OF THE DRAWINGS

FIG. 1 shows an exemplary configuration of a test apparatus 100 that judges pass/fail of a signal under measurement.

FIG. 2 shows an exemplary operation of the frequency counter 10.

FIG. 3 shows exemplary noise in a signal under measurement measured by the measurement apparatus 300.

FIG. 4 shows other exemplary noise in a signal under measurement measured by the measurement apparatus 300.

FIG. 5 shows an exemplary frequency characteristic of measurement by the measurement apparatus 300.

FIG. 6 shows the frequency characteristic of the measurement apparatus 300 shown in FIG. 5 superimposed on the frequency characteristic of the flicker noise.

FIG. 7 shows exemplary calculation results of the noise calculating section 32 when the measurement period is changed.

FIG. 8 shows an exemplary measurement spectrum of the flicker noise obtained from the calculated value S1 in FIG. 7.

FIG. 9 shows an exemplary measurement spectrum of the flicker noise obtained from the calculated value S2 in FIG. 7.

FIG. 10 shows exemplary average periods Ta calculated for each of the counting steps by the average period calculating section 20.

FIG. 11 shows exemplary average periods Ta calculated for each of the counting steps corrected by the noise calculating section 32.

FIG. 12 shows another exemplary configuration of the measurement apparatus 300.

FIG. 13 shows another exemplary configuration of the device under test 200.

FIG. 14 shows another exemplary configuration of the measurement apparatus 300.

FIG. 15 shows another exemplary configuration of the measurement apparatus 300.

FIG. 16 shows another exemplary configuration of the device under test 200.

FIG. 17 shows an exemplary configuration of the electric device 400.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

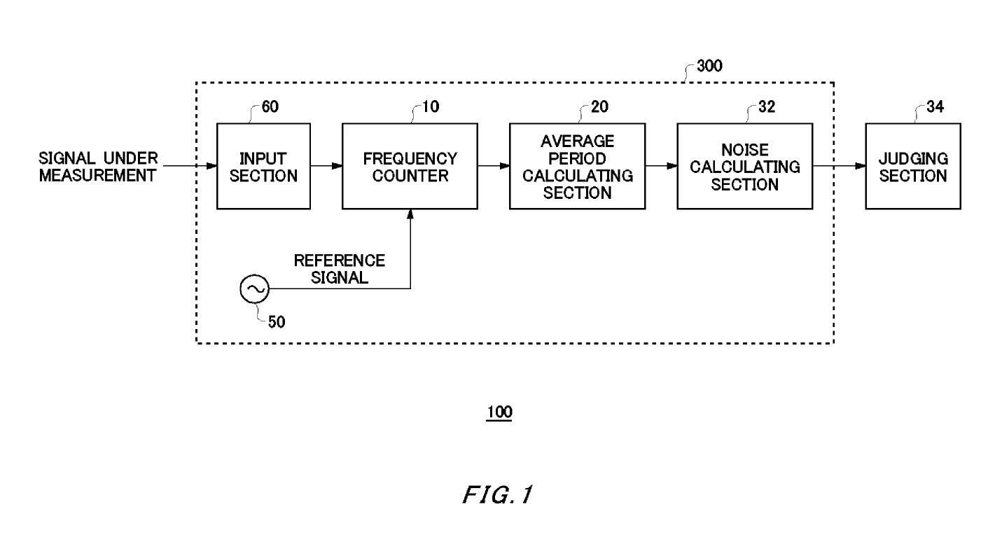

FIG. 1 shows an exemplary configuration of a test apparatus 100 that judges pass/fail of a signal under measurement. The test apparatus 100 may judge pass/fail of a signal under measurement output from a device under test, such as a semiconductor device. The test apparatus 100 includes a measurement apparatus 300 and a judging section 34.

The measurement apparatus 300 measures the noise in the signal under measurement. For example, the measurement apparatus 300 may measure jitter in the signal under measurement. The measurement apparatus 300 includes an input section 60, a frequency counter 10, an average period calculating section 20, a noise calculating section 32, and a reference signal generating section 50.

The input section 60 inputs the signal under measurement received from the outside to the frequency counter 10. The reference signal generating section 50 may generate a reference signal with a predetermined frequency and input the reference signal to the frequency counter 10. The reference signal generating section 50 may be an oscillator.

The frequency counter 10 counts in parallel the number of pulses of the signal under measurement and the number of pulses of a reference signal whose period is known, within the same measurement period. The frequency counter 10 performs a plurality of repetitions of this counting step, which involves counting in parallel the number of pulses of the signal under measurement and the reference signal within the same measurement period. The frequency counter 10 may set the measurement period to be a time period in which n pulses of the signal under measurement are counted, where n is a natural number.

The average period calculating section 20 calculates the average period of the signal under measurement in each measurement period, based on the period of the reference signal and a ratio between the number of pulses of the signal under measurement and the number of pulses of the reference signal counted within the same measurement period. The average period Ta of the signal under measurement in each measurement period is expressed as shown below.

Ta=(m×Tr)/n

Here, m is a natural number indicating the number of pulses of the reference signal counted in the measurement period, and Tr indicates the period of the reference signal. The average period calculating section 20 calculates the average period Ta corresponding to the count results, for each repetition of the counting step.

The noise calculating section 32 calculates spread of a plurality of average periods Ta calculated by the average period calculating section 20 for the plurality of counting steps. The spread of the average periods Ta is a statistical value corresponding to the distribution of the average periods Ta, such as a peak-to-peak value, an RMS value, or a standard deviation of the average periods Ta.

The judging section 34 judges pass/fail of the signal under measurement based on the spread of the average periods Ta. The judging section 34 may judge whether the statistical value indicating the spread of the average periods Ta fulfills a predetermined standard.

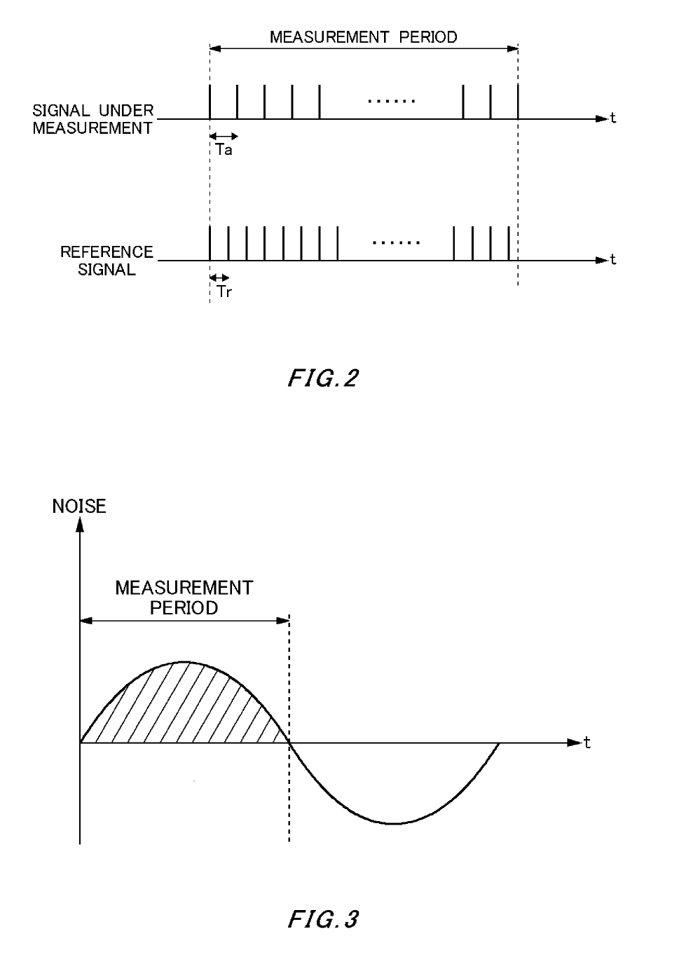

FIG. 2 shows an exemplary operation of the frequency counter 10. FIG. 2 shows the timings of rising edges of the pulses of the signal under measurement and the reference signal. As described above, the frequency counter 10 counts in parallel the number of pulses of the signal under measurement and the reference signal within a prescribed measurement period. The measurement period may be a time period in which n pulses of the signal under measurement are counted by the frequency counter 10, or may be a time period in which m pulses of the reference signal are counted by the frequency counter 10.

FIG. 3 shows exemplary noise in a signal under measurement measured by the measurement apparatus 300. In FIG. 3, the horizontal axis represents time and the vertical axis represents strength of the period jitter. The strength of the period jitter indicates the degree to which the length of each cycle in the signal under measurement deviates from the ideal length, for example.

The average period Ta of the signal under measurement is the sum of (i) the ideal period of the signal under measurement and (ii) a value obtained by dividing the integrated value of the period jitter in the measurement period by the number of pulses n of the signal under measurement. Since the ideal period of the signal under measurement is constant, change in the average period Ta of the signal under measurement corresponds to period jitter.

The integrated value of the period jitter in the measurement period changes according to the relative phase of the jitter with respect to the measurement period. The following describes the example shown in FIG. 3, in which sinusoidal jitter with a period that is half the measurement period is included in the signal under measurement. In this case, the integrated value of the jitter within the measurement period is at a maximum when the initial phase of the sinusoidal jitter matches the start timing of the measurement period, as shown in FIG. 3. The initial phase of the sinusoidal jitter refers to the phase at which the level of the sine wave transitions from negative to positive. The integrated value of the jitter in the measurement period is at a minimum when the initial phase of the sinusoidal jitter is shifted by it from the start timing of the measurement period.

In this way, the measured jitter value changes according to the relative phase of the signal under measurement with respect to the measurement period, and therefore the frequency counter 10 preferably repeats the counting step, which involves counting the number of pulses of the signal under measurement and the reference signal within the same measurement period, a plurality of times. The average period calculating section 20 then calculates the peak-to-peak value or the like of the average period Ta of the signal under measurement calculated for each counting step.

The measurement period of the frequency counter 10 is preferably set to not be an integer multiple of the jitter period of the signal under measurement, and also to not be equal to one divided by an integer multiple of the jitter period. Generally, the jitter and the measurement period of the frequency counter are not synchronized, but the start timing or the end timing of the measurement period of the frequency counter 10 may be controlled to prevent the measurement period from being constant, thereby preventing synchronization between the jitter and the measurement period. For example, the jitter and the measurement period can be made asynchronous by changing the count value of the number of pulses of the signal under measurement or the reference signal designated for the measurement period. As one example, when the measurement period is a time period in which n pulses of the signal under measurement are counted, the frequency counter 10 may change the value of n.

The jitter can be measured while reducing the effect of jitter on the phase by measuring the jitter of the signal under measurement over a plurality of counting steps. When using the frequency counter 10, the measurement gain of the jitter changes according to the jitter frequency.

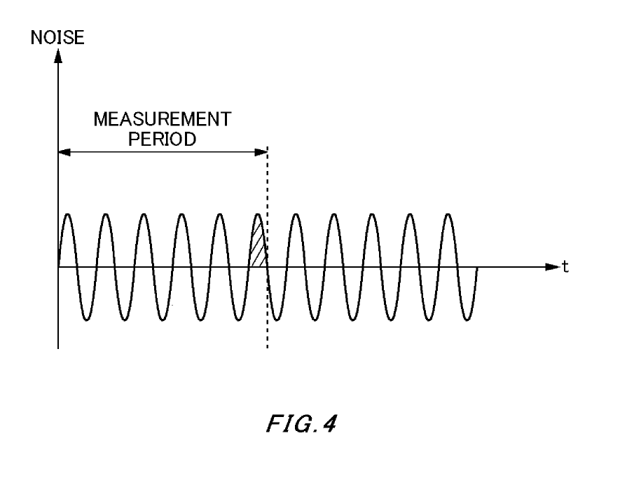

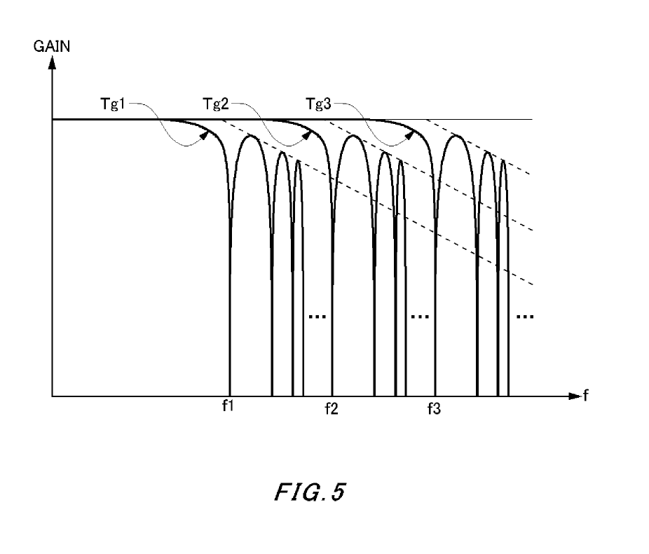

FIG. 4 shows other exemplary noise in the signal under measurement measured by the measurement apparatus 300. In FIG. 4, the horizontal axis represents time, and the vertical axis represents the strength of the period jitter. The period of the period jitter shown in FIG. 4 is 1/5.5 times the measurement period. In this case, the integrated value of the jitter in the measurement period is at a maximum when the initial phase of the sinusoidal jitter matches the start timing of the measurement period.

However, the top portions and bottom portions of the first five cycles of the sinusoidal jitter cancel each other out, and therefore the measured period jitter is only the top portion of the final wave. The top portion of a wave refers to the portion in which the level of the jitter waveform is positive. The bottom portion of a wave refers to the portion in which the level of the jitter waveform is negative. Therefore, if the integrated value of the example in FIG. 3 is ½, the integrated value of the measured period jitter in the example of FIG. 4 is 1/11. In this way, in the measurement using the frequency counter 10, the measurement gain of the jitter changes according to the jitter frequency.

FIG. 5 shows an exemplary frequency characteristic of measurement by the measurement apparatus 300. In FIG. 5, the horizontal axis represents a logarithm of the jitter frequency, and the vertical axis represents decibels of the measurement gain. Furthermore, the vertical axis in FIG. 5 indicates measurement gain obtained when measuring noise power. FIG. 5 shows the frequency characteristics for each of the measurement periods Tg1, Tg2, and Tg3.

As made clear by FIG. 3, when the jitter period is less than or equal to double the measurement period, at least some of the top wave portions and at least some of the bottom wave portions of the jitter are included in the measurement period, regardless of the phase of the jitter. Therefore, when the jitter period is less than or equal to double the measurement period, at least part of the top portions and the bottom portions cancel each other out, thereby attenuating the measurement gain. The jitter frequency in a case where the jitter period is double the measurement period is set as the attenuation start frequency.

When the jitter period is smaller, as shown in FIGS. 3 and 4, the region in which the top wave portions and bottom wave portions cancel each other out is increased. Therefore, the measurement gain of the jitter is gradually attenuated in a band wherein the jitter frequency is greater than or equal to the attenuation start frequency. In the present example, the measurement gain of the jitter is attenuated by −20 dB/dec within the band that is greater than or equal to the attenuation start frequency. As described above, the attenuation start frequency depends on the length of the measurement period, and therefore when the measurement period changes between Tg1, Tg2, and Tg3, the attenuation start frequency also changes. In the example of FIG. 5, Tg1>Tg2>Tg3.

When the jitter period is equal to one divided by an integer multiple of the measurement period, the top wave portions and the bottom wave portions of the jitter in the measurement period completely cancel each other out, and therefore the measurement gain at this frequency is zero. It should be noted that the ridge line, which is the dotted line connecting the peaks in FIG. 5, has a slope of −20 dB/dec, as described above.

As shown in FIG. 5, the frequency characteristic of the noise measurement of the measurement apparatus 300 can be controlled by controlling the measurement period of the frequency counter 10. The measurement apparatus 300 may further include a control section that controls the measurement period of the frequency counter 10. As shown in FIG. 5, the measurement apparatus 300 has the characteristics of a low-pass filter. Therefore, the noise calculating section 32 may calculate the flicker noise, which has relatively low frequency, included in the signal under measurement.

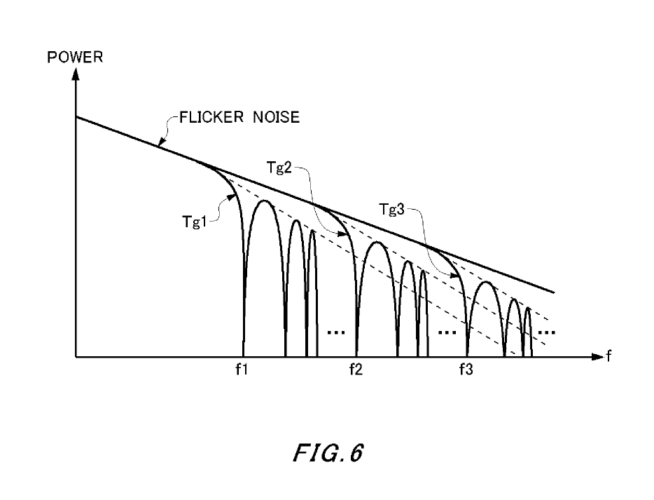

FIG. 6 shows the frequency characteristic of the measurement apparatus 300 shown in FIG. 5 superimposed on the frequency characteristic of the flicker noise. In other words, FIG. 6 shows the frequency characteristic of measurement results obtained when the power of the flicker noise is measured by the measurement apparatus 300. The flicker noise refers to noise whose strength is proportional to 1/f. As described in relation to FIG. 5, the frequency characteristic of the measurement apparatus 300 shows a constant gain in the band that is less than or equal to the attenuation start frequency. Therefore, the frequency characteristic after the superimposition attenuates the gain by −20 dB/dec in the band that is less than or equal to the attenuation start frequency, in the same manner as the flicker noise.

In the band that is greater than or equal to the attenuation start frequency, the gain of the frequency characteristic of the measurement apparatus 300 is attenuated by −20 dB/dec, and therefore the measurement result in this region is attenuated by −40 dB/dec. A value obtained by integrating the frequency characteristic over the frequency axis after the superimposition shown in FIG. 6 corresponds to the measured value of the flicker noise on the time axis, and therefore the frequency characteristic of the flicker noise included in the signal under measurement can be calculated from the calculation results of the noise calculating section 32.

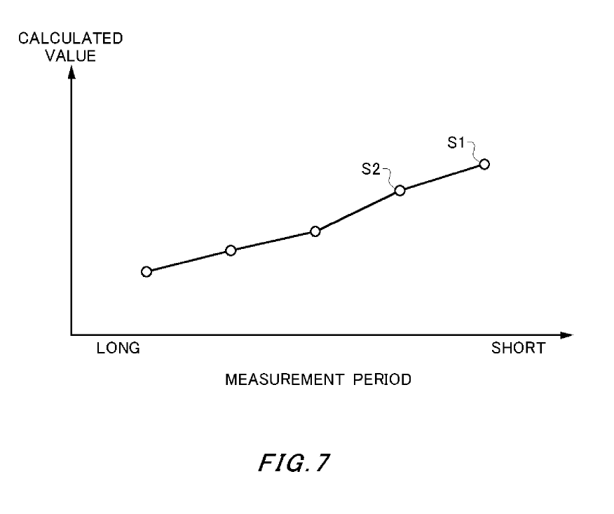

FIG. 7 shows exemplary calculation results of the noise calculating section 32 when the measurement period is changed. In the present embodiment, the frequency counter 10 changes the measurement period every time a predetermined number of counting steps are performed. This predetermined number is preferably a number such as 1000, which is large enough that sufficient measurement of the peak-to-peak value or the like indicating the spread of the average period Ta of the signal under measurement can be achieved. The noise calculating section 32 may calculate, for each set of a predetermined number of counting steps, the peak-to-peak value or the RMS value indicating the spread of the average period Ta of the signal under measurement.

As shown in FIG. 6, the frequency characteristic of the measurement apparatus 300 changes when the measurement period changes, and therefore the value calculated by the noise calculating section 32 also changes. More specifically, when the measurement period is increased, the attenuation start frequency is decreased and the integrated value of the frequency characteristic is also decreased. Accordingly, the calculated value of the noise on the time axis also decreases, as shown in FIG. 7.

The noise calculating section 32 may calculate a spectrum of the flicker noise included in the signal under measurement based on the calculated value, such as the peak-to-peak value or the RMS value, indicating the spread of the average period Ta of the signal under measurement. The noise calculating section 32 calculates the spread of the average period Ta for each measurement period value. The noise calculating section 32 may determine the spectrum of the flicker noise based on the spread of the calculated plurality of average periods Ta.

More specifically, the noise calculating section 32 calculates the measurement spectrum of the flicker noise based on each calculated value. The RMS value of the flicker noise on the time axis corresponds to the integrated value of the power spectrum on the frequency axis. More specifically, the RMS value on the time axis can be calculated from the square root of the integrated value of the power spectrum. It is known that the measurement spectrum of the flicker noise is attenuated by −20 dB/dec in the band that is less than or equal to the attenuation start frequency and by −40 dB/dec in the band that is greater than or equal to the attenuation start frequency, and therefore the measurement spectrum of the flicker noise can be calculated from the RMS value of the flicker noise on the time axis.

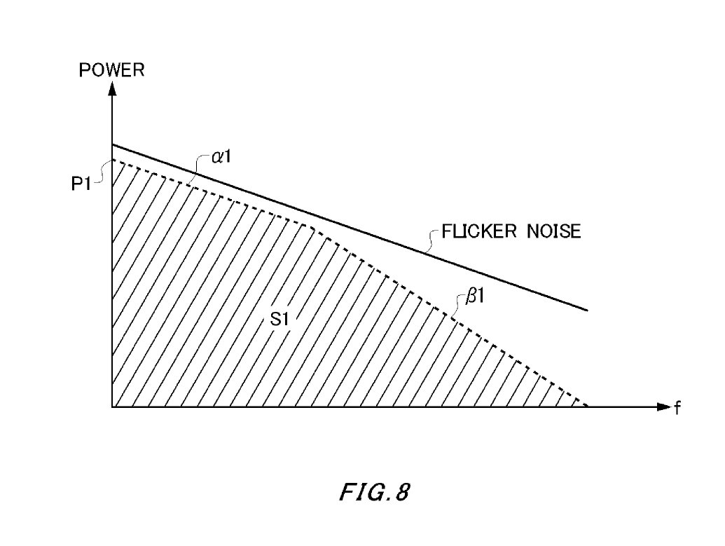

FIG. 8 shows an exemplary measurement spectrum of the flicker noise obtained from the calculated value S1 in FIG. 7. In FIG. 8, the calculated measurement spectrum is shown by the dashed line. The flicker noise actually included in the signal under measurement is shown by the solid line. As described above, the measurement spectrum α1 in the band that is less than or equal to the attenuation start frequency is attenuated by −20 dB/dec. The measurement spectrum β1 in the band that is greater than or equal to the attenuation start frequency is attenuated by −40 dB/dec.

The attenuation start frequency can be determined by the measurement period of the frequency counter 10. Accordingly, by calculating the power P1 at the base frequency f=0 such that the integrated value of the measurement spectrum becomes a value corresponding to the calculated value S1, the measurement spectrum corresponding to the calculated value Si can be determined. The noise calculating section 32 may calculate the power P1 of the measurement spectrum at the base frequency based on the calculated value S1. The noise calculating section 32 may obtain the spectrum of the flicker noise by calculating the spectrum in which the attenuation is −20 dB/dec from the power P1.

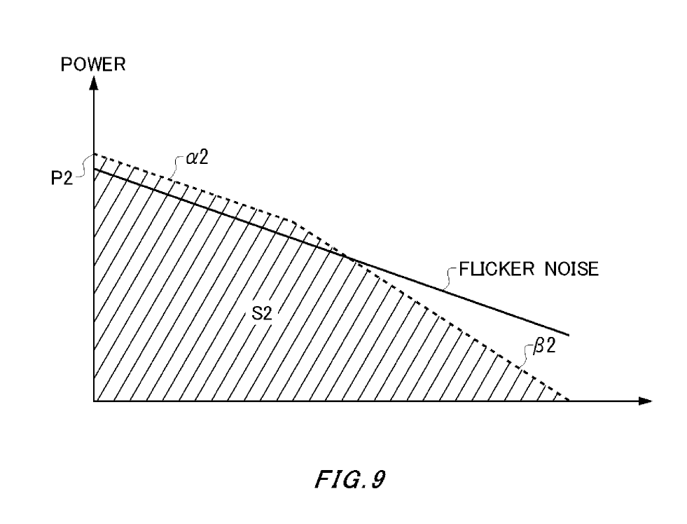

FIG. 9 shows an exemplary measurement spectrum of the flicker noise obtained from the calculated value S2 in FIG. 7. The noise calculating section 32 may calculate the measurement spectrum corresponding to the calculated value S2 as described in relation to FIG. 8. The noise calculating section 32 may calculate a plurality of measurement spectra corresponding to a plurality of calculated values S1, S2, etc., in order to decrease the measurement error. The spectrum of the flicker noise may then be determined from the plurality of measurement spectra.

For example, the noise calculating section 32 may calculate the average value Pa of a plurality of powers P1, P2, etc. of a plurality of measurement spectra at the base frequency. The noise calculating section 32 then sets the spectrum of the flicker noise to be the spectrum that is attenuated by −20 dB/dec from the average value Pa. The judging section 34 may judge pass/fail of the signal under measurement based on the spectrum of the flicker noise. For example, the judging section 34 may judge pass/fail of the signal under measurement based on whether the average value Pa described above is within a prescribed range.

As a result of the above process, the flicker noise in the signal under measurement can be analyzed to judge pass/fail of the signal under measurement. In the above example, the noise calculating section 32 determines the spectrum of the flicker noise from the calculated values S1, S2, etc., but as another example, the noise calculating section 32 may determine the spectrum of the flicker noise from a single calculated value.

The noise measured by the measurement apparatus 300 is not limited to the flicker noise. The measurement apparatus 300 may use the above process to measure noise having a spectrum with a known slope in a predetermined low-frequency band. The measurement apparatus 300 may receive the slope of the spectrum in advance from a user or the like. The measurement apparatus 300 may calculate the noise spectrum of a constant power at each frequency, such as white noise.

The predetermined low-frequency band may be set according to the attenuation start frequency. For example, the predetermined low-frequency band may be a band from 0 to a frequency that is 2 to 10 times the attenuation start frequency.

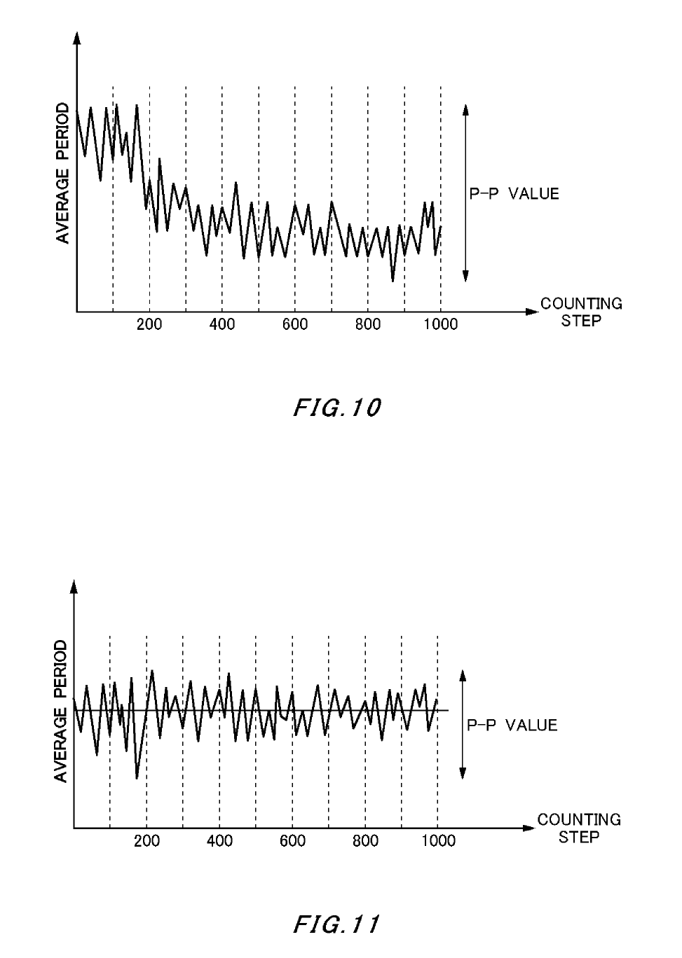

FIG. 10 shows exemplary average periods Ta calculated for each of the counting steps by the average period calculating section 20. In this example, the average period Ta of the signal under measurement changes over time due to reasons other than jitter, such as temperature change or power supply change. In such a case, when the peak-to-peak value, RMS value, or the like is calculated based on the calculation results of the average period calculating section 20, the jitter cannot be accurately calculated due to the effect of this change over time.

FIG. 11 shows exemplary average periods Ta calculated for each of the counting steps and corrected by the noise calculating section 32. The noise calculating section 32 corrects each value of the average period Ta such that average value of the spread of the average period Ta remains substantially constant, every time a predetermined number of counting steps are performed. In the example of FIG. 11, the noise calculating section 32 divides the average periods Ta shown in FIG. 10 into groups, where each group includes 100 counting steps. The value of the average period Ta in each group is then shifted such that the average values of the average periods Ta in each group are substantially constant.

The noise calculating section 32 calculates the peak-to-peak value, RMS value, or the like of the jitter based on the corrected average periods Ta. As a result of this process, the effect of the change over time in the average period Ta of the signal under measurement can be decreased, thereby enabling accurate measurement of the jitter.

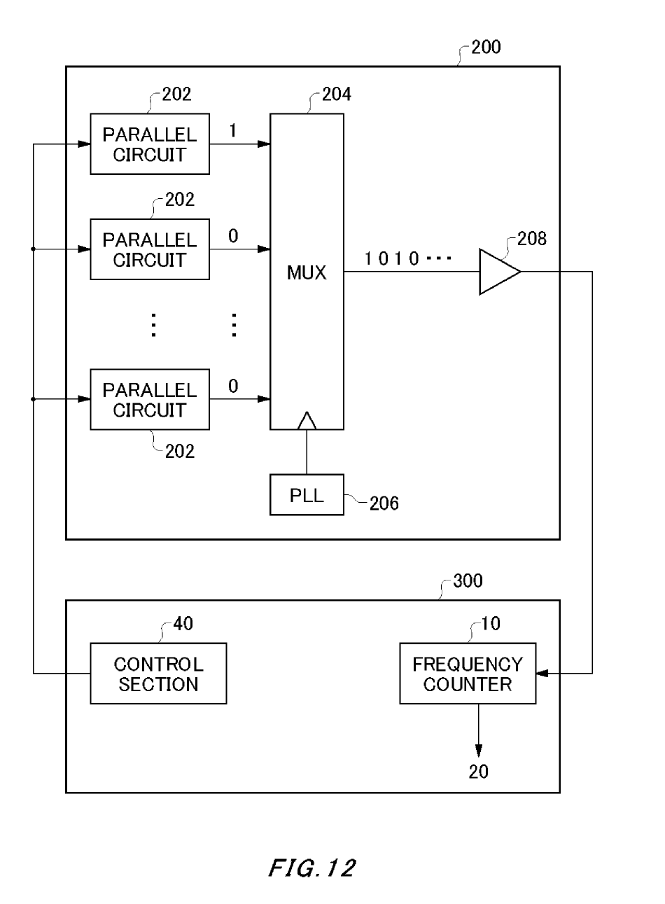

FIG. 12 shows another exemplary configuration of the measurement apparatus 300. The measurement apparatus 300 of the present embodiment further includes a device control section 40 in addition to the configuration of the measurement apparatus 300 described in relation to FIGS. 1 to 11. The measurement apparatus 300 may judge pass/fail of a device under test 200 that outputs a signal under measurement. For example, the measurement apparatus 300 may judge pass/fail of the device under test 200 based on whether a jitter measurement value of the signal under measurement is within a predetermined range.

The device under test 200 may be a SerDes circuit, and includes a plurality of parallel circuits 202 arranged in parallel, a clock generating section 206 that generates an operation clock, a converting section 204, and an output buffer 208. The converting section 204 outputs a serial signal generated by sequentially selecting parallel signals acquired from the parallel circuits 202, according to an operation clock. The output buffer 208 outputs the serial signal to the outside.

The device control section 40 controls the parallel circuits 202 such that the serial signal output from the converting section 204 becomes a clock signal that alternates between logic H and logic L according to the operation frequency of the converting section 204. For example, the device control section 40 may alternate between fixing a logic value of H and a logic value of L for the logic value output by each parallel circuit 202, according to the order in which the parallel circuits 202 are selected by the converting section 204. For example, the device control section 40 may fix the output of parallel circuits 202 that are even-numbered selections to be logic L and fix the output of parallel circuits 202 that are odd-numbered selections to be logic H.

As a result, the serial signal output by the converting section 204 can be made into a clock signal with a constant period. After the device control section 40 has controlled the output of the parallel circuits 202, the frequency counter 10 measures the serial signal output by the converting section 204. With this control, the jitter caused by the converting section 204, the clock generating section 206, and the like can be measured using the measurement apparatus 300.

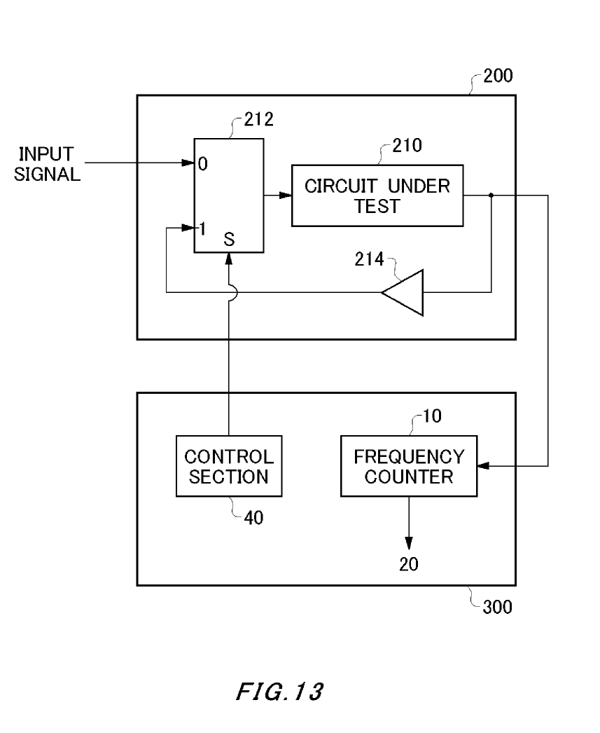

FIG. 13 shows another exemplary configuration of the device under test 200. The device under test 200 of the present embodiment includes a circuit under test 210, a feedback section 214, and a selecting section 212. The measurement apparatus 300 has the same configuration as the measurement apparatus 300 shown in FIG. 12. The circuit under test 210 outputs an output signal corresponding to an input signal. The circuit under test 210 may include a delay circuit, for example. If the device under test 200 is loaded on an electric device, the circuit under test 210 may include a circuit that performs a portion of the functions of the electric device.

The feedback section 214 receives the output signal from the circuit under test 210, which is branched from an output line of the circuit under test 210, and feeds this signal back to the circuit under test 210 as an input signal. The selecting section 212 selects which of an input signal from the outside and the signal from the feedback section 214 is input to the circuit under test 210.

The device control section 40 causes the selecting section 212 to select the signal from the feedback section 214. By feeding back the signal output by the circuit under test 210 into the circuit under test 210 as input, the circuit under test 210 can output an oscillated signal with a prescribed period. After the device control section 40 has controlled the output of the parallel circuits 202, the frequency counter 10 measures the signal output by the converting section 204. With the control described above, a change in the delay amount of the circuit under test 210 can be measured using the measurement apparatus 300.

The measurement apparatus 300 may change the delay setting of the circuit under test 210 and measure the change in the delay amount of the circuit under test 210 for each delay setting. The device under test 200 may include two each of the circuits under test 210, the feedback sections 214, and the selecting sections 212 in parallel, thereby forming two loops. When measuring the change in the delay amount at each delay setting for one of the circuits under test 210, the measurement apparatus 300 can compensate for the effect of the change in temperature or the like over time by measuring the delay amount of the other circuit under test 210 in parallel.

Specifically, the first circuit under test 210 and the second circuit under test 210 receive a power supply voltage from a common power supply. The first selecting section 212 and the second selecting section 212 each receive a signal from the corresponding feedback section 214, and both receive a common input signal. The first feedback section 214 and the second feedback section 214 each feed back, to the corresponding selecting section 212, the signal output by the corresponding circuit under test 210.

The measurement apparatus 300 sequentially sets different delay setting values in the first circuit under test 210. At this time, the measurement apparatus 300 does not change the delay setting value of the second circuit under test 210. For each delay setting value, the measurement apparatus 300 measures the spread of the average period Ta of the oscillated signal output by the first circuit under test 210, i.e. the change in the delay amount of the first circuit under test 210. At this time, the measurement apparatus 300 measures, in parallel, the spread of the average period Ta of the oscillated signal output by the second circuit under test 210. The measurement apparatus 300 may include two frequency counters 10 and two average period calculating sections 20.

Since the delay setting value of the second circuit under test 210 does not change, the overall change of the average period Ta calculated by the average period calculating section 20, with respect to the oscillated signal output by the second circuit under test 210, represents the effect of the temperature change or the like. Therefore, the noise calculating section 32 corrects the average period Ta calculated by the average period calculating section 20 for the oscillated signal output by the first circuit under test 210, by using the average period Ta calculated by the average period calculating section 20 for the oscillated signal output by the second circuit under test 210.

More specifically, the noise calculating section 32 may detect a long-term change in the average period Ta calculated by the average period calculating section 20 for the oscillated signal output by the second circuit under test 210. For example, the noise calculating section 32 may detect a low-frequency component of the change of the average period Ta calculated by the average period calculating section 20. The noise calculating section 32 can compensate for the long-term change over time in the measurement result, by subtracting this low frequency component from the average period Ta calculated by the average period calculating section 20 for the oscillated signal output by the first circuit under test 210.

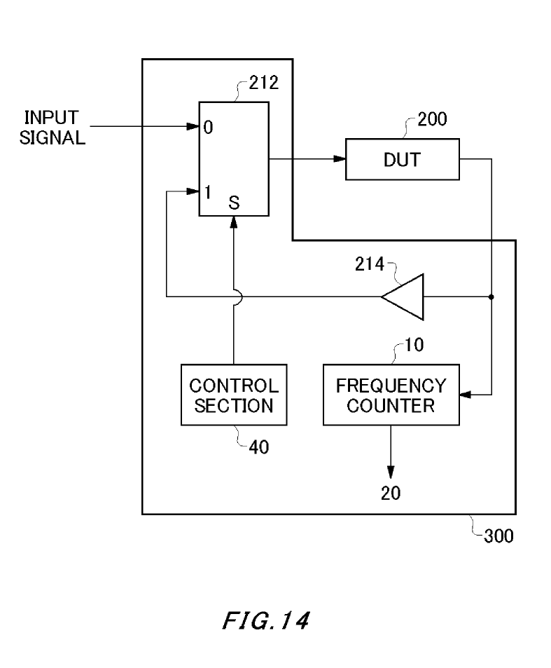

FIG. 14 shows another exemplary configuration of the measurement apparatus 300. The device under test 200 of the present embodiment includes a delay circuit or the like, and outputs an output signal corresponding to an input signal. This measurement apparatus 300 further includes a selecting section 212, a feedback section 214, and a device control section 40 in addition to the configuration of the measurement apparatus 300 described in relation to FIGS. 1 to 11. The selecting section 212 and the feedback section 214 may be provided on a substrate, such as a performance board, on which the device under test 200 is loaded.

The functions of the selecting section 212, the feedback section 214, and the device control section 40 may be the same as the functions of the selecting section 212, the feedback section 214, and the device control section 40 described in relation to FIG. 13. In other words, the measurement apparatus 300 of the present embodiment differs from the measurement apparatus 300 of FIG. 13 by including the selecting section 212 and the feedback section 214 described in relation to FIG. 13. With this configuration, the change in the delay amount of the device under test 200 can be measured using the measurement apparatus 300.

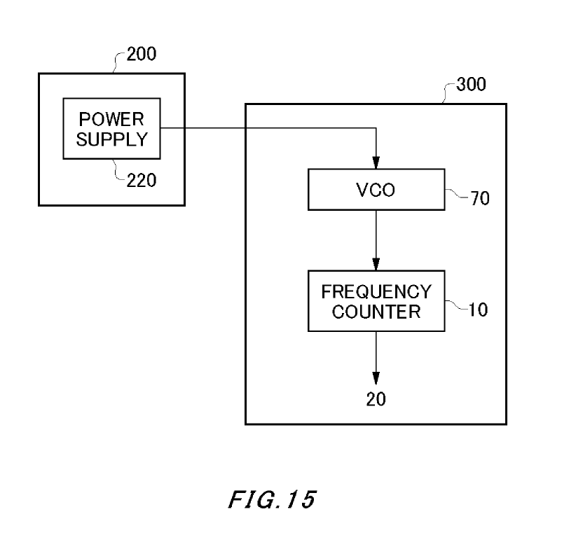

FIG. 15 shows another exemplary configuration of the measurement apparatus 300. The measurement apparatus 300 of the present embodiment further includes a voltage-controlled oscillator 70 in addition to the configuration of the measurement apparatus 300 described in relation to FIGS. 1 to 11. The device under test 200 of the present embodiment includes a power supply 220.

The voltage-controlled oscillator 70 receives the voltage generated by the power supply 220 and outputs an oscillated signal with a frequency corresponding to the voltage. The frequency counter 10 measures the oscillated signal output by the voltage-controlled oscillator 70. With this configuration, the power supply voltage change of the power supply 220 can be detected.

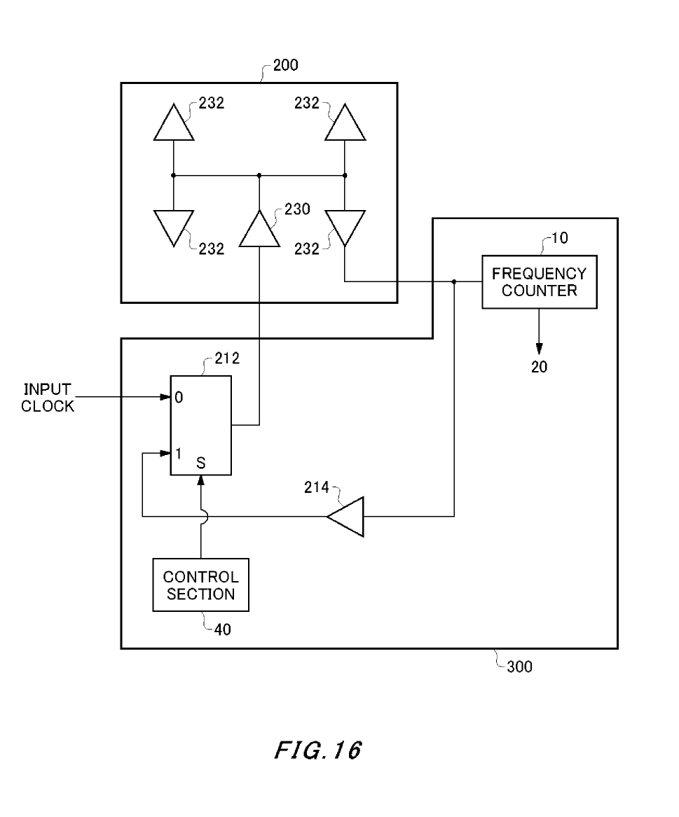

FIG. 16 shows another exemplary configuration of the device under test 200. The measurement apparatus 300 has the same configuration as the measurement apparatus 300 shown in FIG. 14. The measurement apparatus 300 of the present embodiment measures the change in the line delay in the clock tree of the device under test 200. The device under test 200 includes an input buffer 230 and a plurality of buffers 232.

The input buffer 230 branches a clock signal input thereto to each of the buffers 232. Each buffer 232 supplies the clock signal received from the input buffer 230 to a corresponding circuit block in the device under test 200. As a result, the same clock can be provided to each circuit block in the device under test 200.

The frequency counter 10 acquires the clock signal output by each buffer 232 outside the device under test 200, and measures these clock signals. The feedback section 214 is provided in parallel with the frequency counter 10, and feeds the clock signal back to the input end of the device under test 200.

The selecting section 212 selects one of an input clock received from the outside and the clock signal fed back from the feedback section 214, and inputs the selected signal to the input buffer 230. The device control section 40 controls the selecting section 212. With this control, a loop is formed that includes a path from the input buffer 230 to a buffer 232, and an oscillated signal can be generated. Therefore, the change in the delay amount of the path in the device under test 200 can be measured. The measurement apparatus 300 may sequentially select each of the buffers 232, and measure the change in the delay amount for each path.

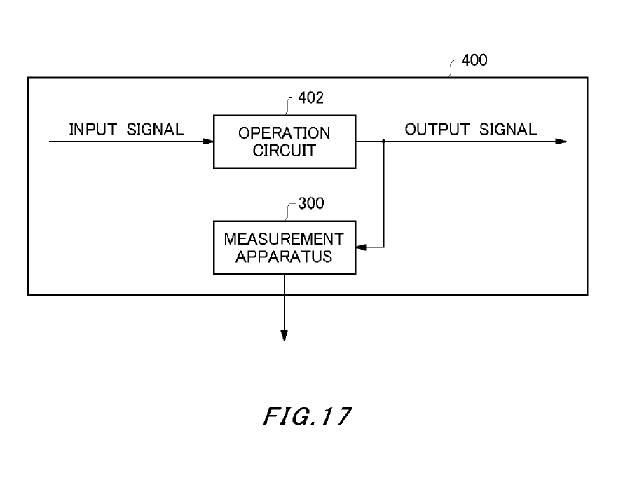

FIG. 17 shows an exemplary configuration of an electric device 400. The electric device 400 includes an operation circuit 402 and a measurement apparatus 300. The operation circuit 402 generates an output signal corresponding to an input signal. For example, if the electric device 400 is implemented in an electric device, the operation circuit 402 may perform a portion of the functions of the electric device.

The measurement apparatus 300 may have the same function and configuration as any one of the measurement apparatuses 300 described in relation to FIGS. 1 to 16. The measurement apparatus 300 measures a signal under measurement output by the operation circuit 402. The measurement apparatus 300 may output to the outside the measurement results concerning the jitter in the signal under measurement.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiments of the present invention can be used to realize a test apparatus, a measurement apparatus, and an electric device that can easily measure jitter in a signal under measurement.

What is claimed is:

1. A test apparatus that judges pass/fail of a signal under measurement, comprising:
a frequency counter that repeatedly performs a counting step of counting the number of pulses of a reference signal whose period is known and the number of pulses of the signal under measurement in parallel within the same measurement period;
an average period calculating section that calculates, for each counting step, an average period of the signal under measurement within the measurement period, based on a period of the reference signal and a ratio between the number of pulses of the signal under measurement and the number of pulses of the reference signal counted within the same measurement period;
a noise calculating section that calculates spread of the average periods calculated by the average period calculating section; and
a judging section that judges pass/fail of the signal under measurement based on the spread of the average periods.

2. The test apparatus according to claim 1, wherein
the frequency counter changes the measurement period every time a predetermined number of the counting steps are performed.

3. The test apparatus according to claim 2, wherein
the noise calculating section calculates a spectrum of noise whose spectrum slope is known within a predetermined low-frequency band, based on the spread of the average periods calculated by the average period calculating section.

4. The test apparatus according to claim 3, wherein
the noise calculating section calculates the spread of the average periods for each of a plurality of values of the measurement period, and determines the spectrum of the noise based on the spread of the average periods.

5. The test apparatus according to claim 2, wherein
the frequency counter repeats the counting step while setting a start timing or end timing of the measurement period of the signal under measurement such that the measurement period is not constant.

6. The test apparatus according to claim 2, wherein
the noise calculating section corrects a value of each average period such that an average value of the spread of the average periods is the same in each set of a predetermined number of counting steps.

7. The test apparatus according to claim 2, wherein
the test apparatus judges pass/fail of a device under test that outputs the signal under measurement,
the device under test includes:
a plurality of parallel circuits arranged in parallel;
a clock generating section that generates an operation clock; and
a converting section that outputs, as the signal under measurement, a serial signal generated by sequentially selecting parallel signals acquired from the parallel circuits, according to the operation clock, and
the test apparatus further comprises a device control section that controls the parallel circuits such that the serial signal is a clock signal that alternates between logic H and logic L according to an operation period of the converting section.

8. The test apparatus according to claim 2, wherein
the test apparatus judges pass/fail of a device under test that outputs the signal under measurement,
the device under test includes:
a circuit under test that outputs an output signal corresponding to an input signal;
a feedback section that receives the output signal output by the circuit under test and branched from an output line of the circuit under test, and feeds the received output signal back to an input end of the circuit under test; and
a selecting section that selects one of the input signal and a signal from the feedback section to be input to the circuit under test, and
the test apparatus further comprises a device control section that causes the selecting section to select the signal from the feedback section.

9. The test apparatus according to claim 2, wherein
the test apparatus judges pass/fail of a device under test that outputs the signal under measurement,
the device under test outputs an output signal corresponding to a signal input thereto, and
the test apparatus further comprises:
a feedback section that receives the signal output by the device under test as the signal under measurement, and feeds the received signal back to the device under test; and
a selecting section that selects one of an input signal input to the test apparatus and the signal from the feedback section to be input to the device under test.

10. A measurement apparatus that measures a signal under measurement, comprising:
a frequency counter that repeatedly performs a counting step, which involves counting a number of pulses of a reference signal whose period is known and a number of pulses of the signal under measurement in parallel within the same measurement period;
an average period calculating section that calculates, for each counting step, an average period of the signal under measurement within the measurement period, based on a period of the reference signal and a ratio between the number of pulses of the signal under measurement and the number of pulses of the reference signal counted within the same measurement period; and
a noise calculating section that calculates spread of the average periods calculated by the average period calculating section.

11. An electronic device housing the measurement apparatus according to claim 10 that measures a signal under measurement output by an operation circuit.
